(19) United States
(12) Patent Application Publication
(10) Pub. No.: US 2005/0009429 A1
(43) Pub. Date: Jan. 13, 2005

(54) Flame retardant and cut resistant fabric

(75) Inventors: Soon C. Park, Woodbury, MN (US); Young Kwon Kim, Woodbury, MN (US); Young-Hwa Kim, Hudson, WI (US)

Correspondence Address: Linda P. Ji;Westman, Champlin & Kelly, Suite 1600, 900 Second Avenue South, Minneapolis, MN, 55402-3319, US

(73) Assignee: Higher Dimension Medical, Inc., Oakdale, MN (US)

(21) Appl. No.: 10/887,005

(22) Filed: Jul. 8, 2004

Related U.S. Application Data
(60) Provisional application No. 60/485,469, filed on Jul. 8, 2003.

(51) Int. Cl. B32B 3/00

(52) U.S. Cl. 442/181; 428/920

(57) ABSTRACT

A cut resistant and flame-retardant fabric-like material. A plurality of guardplates are made of a flame-retardant material and resin is affixed to a fabric substrate to provide a fabric-like material with superior cut resistant and flame-retardant properties. An optional second plurality of guardplates can be affixed to substrate opposite a first layer of guardplates. Also, an optional layer can be disposed over the guardplates to add another property to the fabric-like material such as heat or abrasion resistance, grip, or additional flame retardance.

The present application is based on and claims the benefit of U.S. provisional patent application Ser. No. 60/485,469, filed Jul. 8, 2003, the content of which is hereby incorporated by reference in its entirety.

### BACKGROUND OF THE INVENTION

In some protective garment applications, the garment fabric or material needs to be both flame or fire-retardant and cut and puncture resistant. One example is fire fighting apparel, including jackets, trousers, gloves and boots, that must offer adequate protection against fire and heat as well as cut and puncture resistance from sharp objects.

Fire-retardant fabrics are also used in homes for such items as curtains and furniture covers. Traditionally, there are two ways to make fire-retardant fabrics. The first involves using fire-retardant fibers in making fabric and the second involves chemical treatment of fabrics.

In the first method, flame-resistant fibers such as aramid or glass fibers, or blends of flame-resistant and flammable fibers are knit or woven to create flame-resistant fabrics and fabric blends. Nomax and Kevlar fabrics are examples of such flame-resistant fabrics. Glass fibers can also be woven into such fabrics that are then used in items such as fire fighting apparel.

However, due to high cost, texture, and appearance, such fabrics are used in specialty gear and industrial applications, and are not commonly found in consumer apparel and household textiles.

The second method involves chemical treatment of fabrics to render them flame resistant or fire retardant. There are many flame-resistant chemical sprays, paints, varnishes and coating products on the market for this purpose. Some are applied in the textile mill during production. Others can be applied on fabrics after production. For example, curtains, draperies, children's pajamas, and other articles in the home can have their burning rates reduced with chemically-applied flame-retardants.

However, most non-toxic chemically-applied liquid flame retardants are water-based. Water-based flame-retardant agents can be washed away from repeated use or washing, thereby gradually reducing the fabric's flame retardant properties. Also, flame-retarding treatment does not generally improve the mechanical strength of fabrics.

### SUMMARY OF THE INVENTION

The present inventions relate to fabrics or flexible fabric-like materials that have superior fire retardant and cut resistant properties. In one aspect, a flame retardant fabric comprises a flexible substrate and a plurality of non-overlapping guardplates affixed to the substrate. The guardplates are arrayed in a pattern such that a plurality of gaps is defined between adjacent guardplates. The guardplates are also made of a flame retardant material. In another aspect, the invention includes the flame retardant material. Finally, further aspects of the invention includes the flame retardant fabric with a layer disposed on the guardplates.

### BRIEF DESCRIPTION OF THE DRAWINGS

FIG. 1 is a top view of the inventive fabrics.

FIG. 2 is a section taken along line A-A in FIG. 1.

FIG. 2A illustrates guardplates permeating and affixed to a substrate.

FIG. 3 is an alternate embodiment of the section taken along line A-A in FIG. 1.

FIG. 4 is a multi-layer embodiment of the inventive fabrics.

FIG. 5 is an alternate embodiment to the multi-layer fabric of FIG. 4.

FIG. 6 illustrates a fabric with two pluralities of guardplates with or without a second substrate.

FIG. 7 illustrates guardplates affixed to both sides of a single substrate.

### DETAILED DESCRIPTION OF THE PREFERRED EMBODIMENTS

The present inventions provide flexible fabrics with properties of (1) flame-retardance and (2) cut/puncture resistance. The current inventive fabrics are unique because the fabrics have a plurality of flame resistant and cut/puncture resistant guardplates affixed to a top surface of a fabric substrate. In some embodiments, the substrate fabrics are not flame resistant nor chemically treated. However, in other embodiments, the flame and cut/puncture resistant guardplates are affixed to a flame resistant fabric such as Nomex® or Kevlar®. The inventive fabrics also do not involve lamination of flame retardant materials that can reduce flexibility.

The fabrics or fabric-like materials described herein achieve flame-retardant and cut and puncture resistant properties by incorporating or affixing discrete plate-like objects (guardplates) onto a flexible fabric substrate. The guardplates are continuous and non-overlapping and are arrayed or arranged in a pattern so that there are gaps between adjacent plates. The guardplate material is designed to be both flame-retardant and cut-resistant and can comprise printable, including screen-printable resins.

The flame-retardant resins are made by mixing known flame-retardant additives, individually or in combination, to known resin materials, individually or in combination. The lists of flame-retardant additives and resins are as follows:

FLAME RETARDANT ADDITIVES
Aluminum trihydroxide
Magnesium hydroxide
Antimony trioxide
Zinc borate
Low melting glasses
Halogenated compounds
Halogenated phosphate
Monoammonium phosphate
Silicone based additives
Ceramic beads
Melamine salts
Intumescent additives
Other known flame retardants additives

RESINS
Epoxy resins
Phenolic resins
Polyvinyl choride (PVC)
Polyoleffins
Polyamides
Elastomers
Halogenated resin compounds
Other known similar materials

Thus, any of the listed flame-retardant additives can be added to any of the resins to yield a flame-retardant resin. However, when selecting flame-retardant additives, resins, and relative amounts, it can be important that the mixture maintain a printable texture and consistency and ability to at least slight permeate and/or affix to the flexible substrate.

The affixed guardplates define a plurality of gaps between adjacent guardplates providing the fabric with flexibility. These gaps are sufficiently narrow to minimize direct exposure of substrate fabric to flame. The gap widths and locations are selected to minimize the presence of straight-line open space along which the fabric can cut or tear. However, gaps between adjacent plates are typically linear.

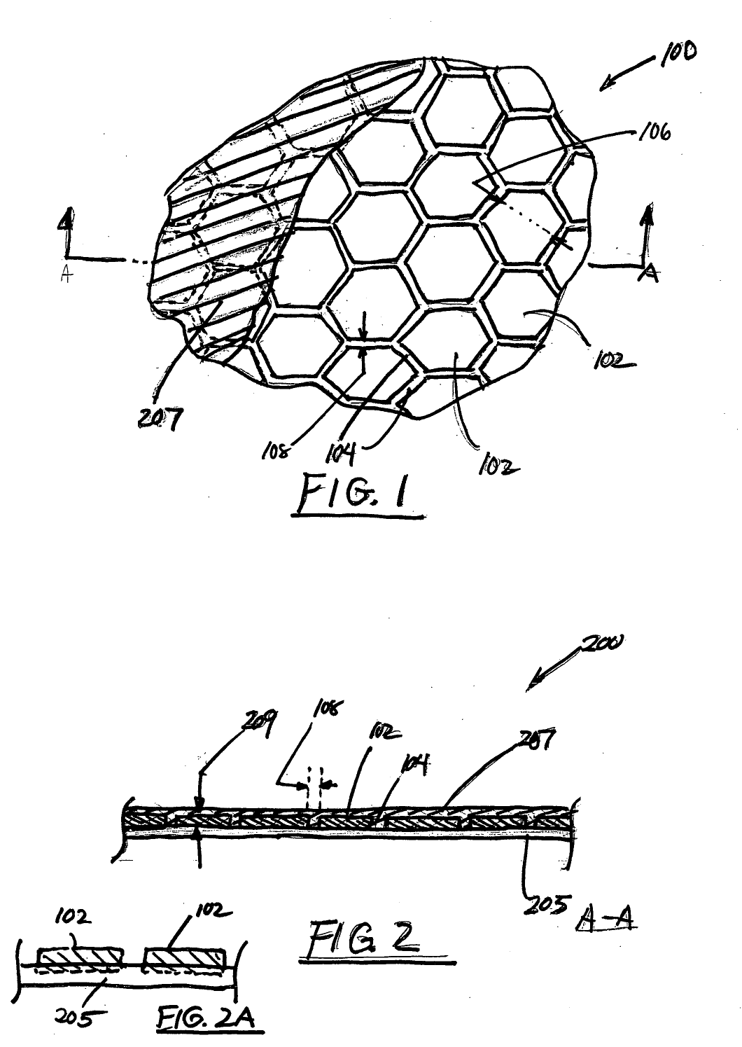

FIG. 1 illustrates one embodiment of the present inventive fabrics. FIG. 2 is a section taken along line A-A as shown in FIG. 1. Fabric 100 comprises flexible substrate 205 and affixed guardplates 102. Guardplates 102 are non-overlapping and arrayed in a pattern such that a plurality of gaps 104 are defined between adjacent guardplates 102. Gaps 104 can be approximately uniform in width. In some embodiments, width 108 can be in the range of 5 to 20 mils. In other embodiments, gap width is approximately 10 to 15 mils. Guardplates 102 comprise a flame-resistant or fire-retardant material. In some embodiments, guardplates 102 are shaped as equilateral hexagons but can be made into other shapes as well. In most embodiments, guardplates 102 have a thickness 209 in the range of approximately 5 to 20 mils thick, depending on desired cut resistance and flame retardance. In other embodiments, guardplate thickness 209 is in the range of approximately 10 to 15 mils. Also, in some embodiments, each guardplate 102 can have diameter 106 in the range of 50 to 120 mils. In other embodiments, diameter 106 is in the range of approximately 70 to 90 mils. In one embodiment, each guardplate 102 has a diameter of approximately 80 mils.

In another embodiment of the present inventions, customized resins comprising both flame-retardant materials such as but not limited to Resin A, Resin B, or Resin C described in Tables 1-4 below, alone or in any combination, and high modulus ceramic beads are used to form the guardplates 102. Resins A, B, and C are specific formulations comprising epoxy-based resin but other formulations can be made from mixing flame-retardant material with conventional epoxy and/or phenol resins.

Substrate 205 can comprise fabrics that are woven, knit, or non-woven, such as but not limited to leather, cotton, or a nylon/cotton blend. Substrate 205 can also comprise a flame-retardant fabric comprising Nomex® or Kevlar®. It is important, however, that substrate 205 is flexible and that the guardplates 102 will adhere to the substrate layer. In most embodiments, guardplates 102 at least slightly permeate substrate 205 in order to affix more securely to substrate 205, especially after curing. In some embodiments, substrate fabrics are selected that can resist heat and won't easily melt in high heat environments, such as fire-fighting. These substrate fabrics include but are not limited to natural fabrics such as cotton, silk, and wool as well as synthetic fabrics with heat resistant properties.

The guardplate resin with or without ceramic beads typically comes in the form of a paste-like material that can be printed onto the surface of the fabric substrate 205 using known screen-printing techniques. The printed resin is then cured through methods such as heat or ultraviolet (UV) curing, to solidify or affix plurality of guardplates 102 on substrate 205. Because of the discrete nature of the printed guardplates 102, the gaps 104 between the guardplates 102 are continuous and relatively uniform in width to enable the finished fabric 100 to maintain both its flexibility and flame-retardant properties. Gaps 104 are also sufficiently narrow to maintain cut and/or puncture resistance as required by design parameters.

FIGS. 1 and 2 also shows layer 207 disposed on or over guardplates 102. Layer 207 can provide features such as high grip strength or friction, heat resistance (i.e. an insulator to minimize heat transfer through the fabric), abrasion resistance, and additional fire-retardance. In some embodiments, layer 207 comprises an elastomeric material, such as silicone. In addition to heat resistance, layer 207 can also provide for grip strength, for example, for fabrics used in gloves. In some embodiments illustrated in FIG. 2, the material of layer 207 is also flexible, which allows the gaps 104 to also be filled yet the fabric 200 remains flexible.

It is important to note that layer 207 can be a continuous layer, such as illustrated in FIG. 1. However, in another embodiment such as illustrated on FIG. 6, a plurality of guardplates 607 comprising materials (such as silicone) similar to layer 207 can be printed onto a top surface of guardplates 102. Guardplates 607 can be registered or unregistered relative to guardplates 102. Guardplates 607 can be the same or different diameters relative to guardplates 102. Generally, it is advantageous to print unregistered guardplates 607 when possible due to lower cost. Further refinements can be found in U.S. Publication No. US-2002-0106953-A1, which published on Aug. 8, 2002, and is herein incorporated by reference in its entirety.

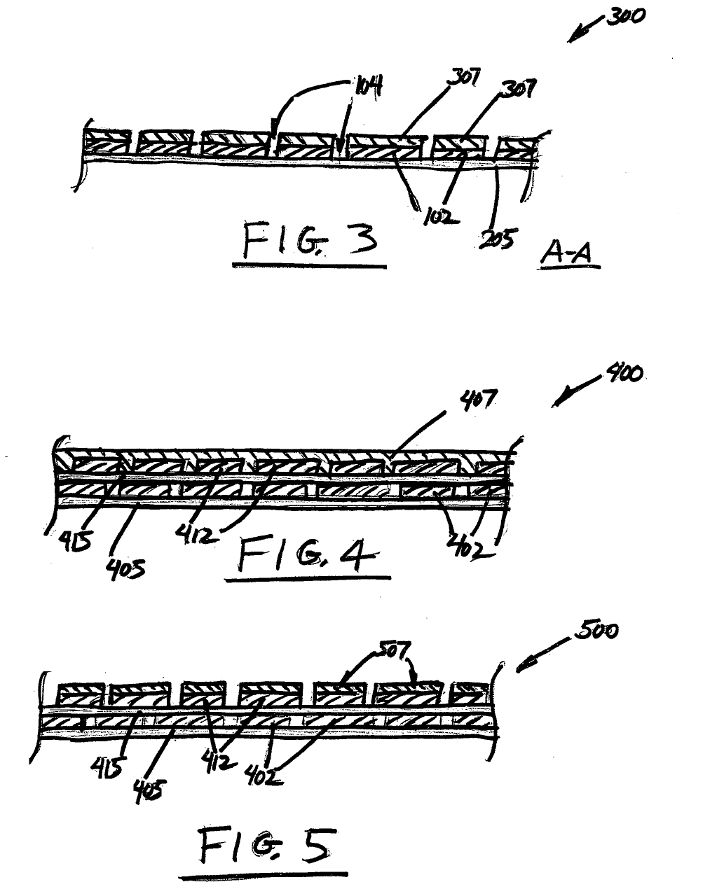

FIG. 3 illustrates an alternate embodiment of the section taken along line A-A in FIG. 1. Fabric 300 comprises flexible substrate 205 and affixed guardplates 102 as before. Layer 307 is disposed over each guardplate 102 and does not fill gaps 104 as in FIG. 2. As above, layer 307 can be an elastomeric material such as silicone. Layer 307 also has the same purpose as layer 207 shown in FIG. 2. However, layer 307 can be advantageous for increased breathability or air circulation due to not covering or filling gaps 104.

FIG. 4 shows a multi-layer fabric 400 comprising stacked substrates 405 and 415 and affixed pluralities of guardplates 402 and 412. Guardplates 402 and/or guardplates 412 can comprise fire retardant resins that are cured as above. Guardplates 402 and 412 can be registered or non-registered. One advantage of not registering guardplates 412 is lower cost. FIG. 6 illustrates as example of non-registered guardplates 607, 102, where guardplates 607 can be printed on a substrate such as substrate 415 or directly on guardplates 102.

Substrates 405 and 415 can comprise flexible fabrics such as but not limited to cotton, leather, nylon/cotton blend, or a flame-retardant fabric on which guardplates 402 and 412 can be printed and affixed. The size, shape and gap size of the guardplates for each layer can be adjusted so as to meet selected flexibility of the fabric 400 and/or to minimize alignment of the gaps between the layers. Multi-layer fabric 400 can provide additional cut and puncture resistance as well as fire-retardance but can lose some overall flexibility compared with the single layer guardplate structures shown in FIGS. 1-3. Layer 407 is structurally similar to layer 207 shown in FIG. 2 and is discussed above and herein incorporated. Further, it is noted that substrate 415 can be loosely or tightly coupled to plates 402. In most embodiments, however, substrate 415 is loosely coupled in that substrate 415 can slide relative to plates 402.

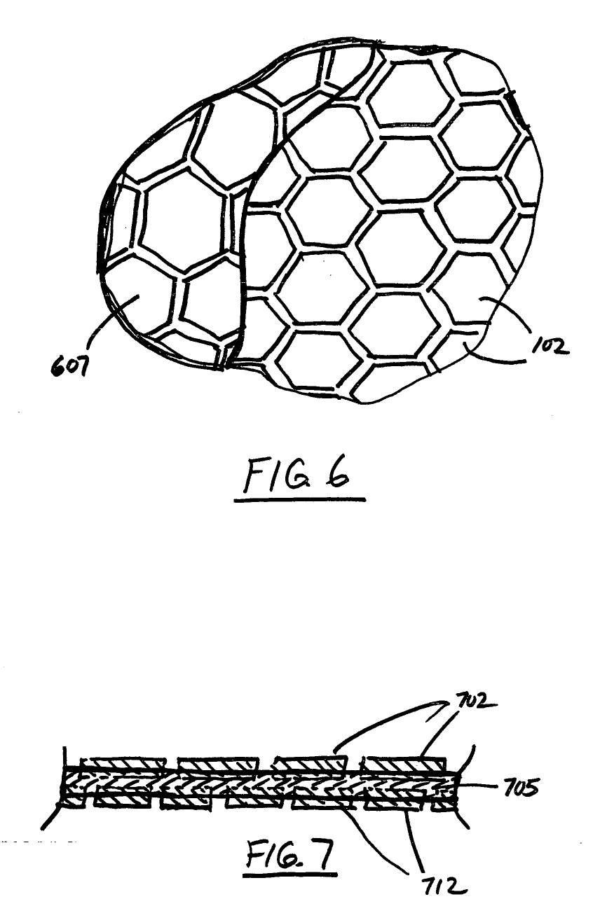

FIG. 5 is an alternate embodiment of the multi-layer fabric shown in FIG. 4. Fabric 500 also contains multiple or stacked substrates 405, 415 and affixed guardplates 402 and 412. Layer 507 is disposed on guardplates 412 and is structurally similar to layer 307 shown in FIG. 3 and is discussed above and herein incorporated.

FIG. 7 illustrates still another embodiment where guardplates 702 are affixed to one side of substrate 705 and guardplates 712 are affixed to an opposite side of substrate 705. Guardplates 702 can be the same or difference size and/or shape relative to guardplates 712. Guardplates 702 can be registered or not registered relative to guardplates 712. However, in most embodiments guardplates 702, 712 are hexagonal, not registered, and have a different diameter relative to guardplates 712.

We give below two examples of resin formulation and test results on flame-retardant and cut resistant properties. The raw materials used in the resin formulations of the present inventions are summarized in Table 1.

TABLE 1
Raw materials used in the invention

| | |
|---|---|
| Epon 828 | diglycidyl ether of bisphenol |
| | A (DGEBA) from Resolution. |
| A-187 | Gamma-Glycidoxypropyltrimethoxy |
| | Silane, from Crompton |
| BYK 995 | dispersion agent from BYK Chemie. |
| BYK 980 | dispersion agent from BYK Chemie. |
| BYK 525 | Air release additive from BYK-Chemie |
| Ancamine 2442 | modified cycloaliphatic/aliphatic amine epoxy |
| | curing agent from Air Products and Chemicals, Inc |
| Amicure CG1200 | Dicyandiamide epoxy curing |
| | agent from Air Products and Chemicals, Inc. |
| BK-5099 | Iron oxide powders, from Whittaker, |
| | Clark & Daniels, Inc. |
| | Aluminum trihydroxides, from |
| Martinal OL-104LE | Albemarle |
| | Aluminum trihydroxides, from |
| Martinal ON-321 | Albemarle |
| M5 | Untreated fumed silica, from Cabot Corp |
| TS 720 | Treated fumed silica, from Cabot Corp |
| Zirblast B125 | Zircon ceramic beads, |
| | from USF surface preparation. |

In one experiment, Resin A was prepared to provide a resin composition to be used for screen-printing on the fabric substrate to provide flame-retardance and cut and/or puncture resistance. To prepare Resin A, Epon 828, A-187, BYK995 and BYK525 were weighed into a 50 ml. polyethylene container and placed in a SpeedMixer® holder (model DAC 150 FV-K, from FlackTek) and mixed at a speed of 2500 rpm. for 30 seconds. The container was taken out of the mixer and the following ingredients were added: Amicure CG1200, amicure 2442, BK5099, Martinal ON-320, Martinal OL-104LE, and TS720. The entire mixture was again placed in SpeedMixer and mixed again at the same conditions.

The mixture was screen printed on blended 65% polyester and 35% cotton fabric using a metal stencil with a guardplate diameter of approximately 80 mils, a gap width of approximately 14 mils, and an approximate uniform thickness of approximately 10 mils. The printed fabric was placed in an oven at 140 C. to heat-cure for 1 hour.

Table 2 below summarizes the raw material components and respective amounts of Resin A. It is noted that these weights are representative of relative amounts and can be multiplied by various factors or constants as needed.

TABLE 2
Resin A formulation in grams or parts by weight:

| Raw Material | Amount |
|---|---|
| Epon 828 | 17.65 |
| A187 | 0.34 |
| BYK995 | 0.34 |
| BYK525 | 0.24 |
| Amicure CG1200 | 1.07 |
| Ancamine2442 | 0.89 |
| BK5099 | 0.08 |
| Martinal ON-320 | 18.86 |
| Martinal OL-104LE | 9.47 |
| TS720 | 1.08 |

The cured fabric identified as Fabric A was then cut into a 15 cm×20 cm piece and placed horizontally onto a metal ring in order to conduct a flame test. A candle was lit and placed under Fabric A with the side having printed guardplates made from Resin A pointing downward and facing the candle flame. Fabric A was exposed to the flame for 30 seconds, then the candle was removed. The area of Fabric A in contact with the candle was observed to glow, but the glow did not spread and gradually disappeared (extinguished). The glow-time after removal of the candle was measured to estimate the flame retardance of Fabric A. The same experiment was repeated for the non-printed side (fabric side opposite guardplates).

Then, for comparison, plain polyester/cotton fabric such as used for the Fabric A substrate was used as a control sample (control fabric) and also flame tested. The candle flame was brought to the Control fabric placed horizontally on the metal ring. The Control fabric burned continuously and the onset time to ignition was measured. The experimental results are summarized in Table 3 below:

TABLE 3
Flame test results

| | time to | | glow time* | | |
|---|---|---|---|---|---|
| | ignition, | | Printed | Non-printed | |
| | both sides | | side | side | Remarks |
| Fabric A | NA | NA | 1 sec | 1.5 sec | Resin A |
| Control | 5 sec | NA | Burned | Burned | Control |
| Fabric | | | | | |

*after 30 sec flame exposure and the candle is removed

For Fabric A, the glow extinguished after removing the flame source after a 30-second exposure. In contrast, the Control fabric burned continuously even after the flame source was removed. Surprisingly, the non-printed side of Fabric A also showed excellent flame retardance and the glow time was only slightly longer than the printed side.

Experiments were also conducted in other fabrics identified as Fabric B and Fabric C using Resin B and Resin C, respectively. In these examples, Resin B and Resin C were formulated for combined properties of flame retardance and higher cut resistance. Table 4 below summarizes the composition of Resins B and C.

TABLE 4
(in grams or parts by weight)

| Component | Resin B | Resin C |
|---|---|---|
| Epon 828 | 24.78 | 24.78 |
| A-187 | 0.48 | 0.48 |
| BYK980 | 0.93 | 0.93 |
| BYK525 | 0.33 | 0.33 |
| Amicure CG1200 | 1.50 | 1.50 |
| Ancamine 2442 | 1.25 | 1.25 |
| BK-5099 | 0.11 | 0.11 |
| Martinal ON-320 | 26.49 | 26.49 |
| Martinal OL-104LE | 13.30 | 13.30 |
| Zirblast B125 | 40 | NA |
| M5 | 1.3 | NA |
| TS720 | 0.67 | 0.67 |

Both Resins B and C were very similar in composition and both comprise flame retardant materials. Resin B has small ceramic beads mixed in the formulation to provide additional cut resistance but Resin C did not have ceramic beads added. The mixing procedure described above in Resin A was used. Resins B and C were screen-printed on 65% polyester and 35% cotton fabric and cured for 1 hour at 140° C. The flame test was conducted with the same procedure described for Resin A and the Control sample. Results for flame retardance and cut resistance for Resins B and C are summarized in Table 5 below:

TABLE 5
Flame retardance and cut resistance

| | |
|---|---|
| glow time* | Cut load, |

| | | Non- | per 10 mil |
|---|---|---|---|
| | | printed | true print |
| | Printed side | side | thickness |
| Ex. B | 1 sec | 1.5 sec | 6 lb |
| Ex. C | 1 sec | 1.5 sec | 3 lb |

*after 30 sec flame exposure

Test results for Resin B and Resin C indicate that adding ceramic beads does not appear to affect flame retardance because both Resin B and Resin C had approximately the same glow time. However, adding ceramic beads improved cut resistance significantly.

Although the present invention has been described with reference to preferred embodiments, workers skilled in the art will recognize that changes may be made in form and detail without departing from the spirit and scope of the invention.

1. A flame-retardant fabric comprising:
a flexible substrate; and
a plurality of non-overlapping guardplates affixed to the substrate, the guardplates arrayed in a pattern such that a plurality of gaps are defined between adjacent guardplates, wherein the guardplates comprise a flame retardant material.

2. The flame-retardant fabric of claim 1, wherein the guardplates have a thickness in the range of approximately 5 to 20 mils.

3. The flame-retardant fabric of claim 2, wherein the guardplates have a thickness in the range of approximately 10 to 15 mils.

4. The flame-retardant fabric of claim 1, wherein the guardplates are approximately hexagonal in shape and have a diameter in the range of approximately 50 to 120 mils.

5. The flame-retardant fabric of claim 4, wherein the guardplates have a diameter in the range of approximately 70 to 90 mils.

6. The flame-retardant fabric of claim 1, wherein the gaps between adjacent guardplates are approximately linear and have a width in the range of approximately 5 to 20 mils.

7. The flame-retardant fabric of claim 6, wherein the gaps are approximately 10 to 15 mils wide.

8. The flame-retardant fabric of claim 1, wherein the flame-retardant material comprises a flame-retardant additive and a resin.

9. The flame-retardant fabric of claim 8, wherein the flame-retardant material comprises at least one of aluminum trihydroxide, magnesium hydroxide, antimony trioxide, zinc borate, low melting glasses, halogenated compounds, halogenated phosphate, monoammonium phosphate, silicone based additives, melamine salts, and intumescent additives.

10. The flame-retardant fabric of claim 8, wherein the resin comprises epoxy resin.

11. The flame-retardant fabric of claim 8, wherein the resin comprises a phenolic resin.

12. A flame retardant fabric of claim 1, wherein the flame retardant material comprises 17.65 parts Epon 828; 0.34 parts A187; 0.34 parts BYK995; 0.24 parts BYK525; 1.07 parts Amicure CG1200; 0.89 parts Ancamine2442; 0.08 parts BK5099; 18.86 parts Martinal ON-320; 9.47 parts Martinal OL-104LE; and 1.08 parts TS720 by weight.

13. The flame-retardant fabric of claim 1, wherein the flexible substrate comprises a woven fabric.

14. The flame-retardant fabric of claim 12, wherein the woven fabric comprises cotton.

15. The flame-retardant fabric of claim 14, wherein the woven fabric comprises a nylon/cotton blend.

16. The flame-retardant fabric of claim 1, wherein the flexible substrate comprises leather.

17. The flame-retardant fabric of claim 1, wherein the flexible substrate is a flame retardant fabric.

18. The flame-retardant fabric of claim 1, further comprising a layer disposed on the guardplates.

19. The flame-retardant fabric of claim 18, wherein the layer is an elastomeric.

20. The flame-retardant fabric of claim 19, wherein the elastomeric comprises silicone.

21. The flame-retardant fabric of claim 18, wherein the layer is a heat insulator.

22. The flame-retardant fabric of claim 18, wherein the layer comprises a second plurality of non-overlapping guardplates affixed to the first-mentioned layer of guardplates.

23. The flame-retardant fabric of claim 1, and further comprising a second plurality of non-overlapping guardplates affixed to the flexible substrate opposite the first-mentioned plurality of guardplates.

24. The flame-retardant fabric of claim 23, wherein the second plurality of guardplates comprises a flame-retardant additive.

25. The flame-retardant fabric of claim 1, wherein the flame-retardant material comprises ceramic beads.

26. A flame-retardant material comprising Epon 828; A187; BYK980; BYK525; Amicure CG1200; Ancamine2442; BK5099; Martinal ON-320; Martinal OL-104LE; and TS720.

27. The flame-retardant material of claim 26 comprising 24.78 parts Epon 828; 0.48 parts A187; 0.93 parts BYK980; 0.33 parts BYK525; 1.50 parts Amicure CG1200; 1.25 parts Ancamine2442; 0.11 parts BK5099; 26.49 parts Martinal ON-320; 13.30 parts Martinal OL-104LE; and 0.67 parts TS720 by weight.

28. The flame-retardant material of claim 26, and further comprising ceramic beads.

29. The flame-retardant material of claim 28, wherein the ceramic beads comprise Zirblast B125 and M5 by weight.
